(19) United States
(12) Patent Application Publication
(10) Pub. No.: US 2012/0025945 A1
(43) Pub. Date: Feb. 2, 2012

(54) MOTION CAPTURE DATA GLOVE

(75) Inventors: Faisal M. Yazadi, San Jose, CA (US); Mark Schelbert, Los Angeles, CA (US); Lawrence Miller, Mountain View, CA (US)

(73) Assignee: CYBERGLOVE SYSTEMS, LLC, San Jose, CA (US)

(21) Appl. No.: 13/192,401

(22) Filed: Jul. 27, 2011

Related U.S. Application Data
(60) Provisional application No. 61/368,179, filed on Jul. 27, 2010.

(51) Int. Cl. H04L 7/00; A41D 13/00; A41D 19/00

(52) U.S. Cl. 340/4.2; 2/160; 2/69

(57) ABSTRACT

The motion capture data glove includes a hand wearable flexible glove having one or more sensors coupled thereto and positioned to measure natural hand movement. A data storage device at least temporarily stores movement information measured by the sensors. The data glove is configured to exchange a common timestamp with a remote device via a communication port for use in association with a synchronous time element configured to impart the timestamp in real-time to the movement information measured by the one or more sensors and stored by the data storage device to synchronize the movement information with other devices operating simultaneously.

### BACKGROUND OF THE INVENTION

The present invention generally relates to a data glove for use in motion capture environments. More particularly, the present invention relates to a motion capture data glove having enhanced data synchronization, on-board data management and storage, and visual identification markers.

Motion capture devices are designed to record, capture, or translate movement in order to digitally reproduce natural body movement. Recent designs use motion capture in the form of body suites, data gloves, facial cams and other devices that are designed to track the movement of various body parts. In this respect, motion capture devices are used to simulate physical movement in digitally enhanced reproductions. Motion capture devices may be used in a variety of ways, including military equipment, entertainment (e.g. movies or television), sports, video games, in the medical field, or in association with robotics. Recent trends in the movie industry use motion capture devices to create digital character models in 2D and 3D environments. These models can be enhanced when used in association with computer animation and other computer generated imagery (CGI).

Motion capture devices are typically designed only to capture the motion of the person wearing the device, and not necessarily the person's visual appearance. This has several applications. For example, CGI may be used to overlay or apply certain graphics to the surface of movement information captured by the motion capture device. In effect, CGI can be used to further animate a scene while substantially maintaining natural movements captured by the motion capture device. In this respect, it is important that the CGI effects can be adequately sequenced or synchronized with the recorded movement data, especially data recorded simultaneously by multiple devices. These types of graphics may be used in movies or video games, for example, to produce more lifelike reproduction of human or other animal movement. In fact, some motion capture devices can even be used to identify subtle expressions of the face and fingers.

In the recording environment, small sensors sample and record movements several times a second. The animation data is mapped to a 3D computer model. The computer model may then be programmed to simulate movement based on the movement of the person wearing the motion capture device. This can be helpful in reproducing lifelike movement or mimicking human movements from a remote location, such as through the use of robotics. Additionally, cameras may also act as motion capture devices so that viewers or those that play role playing video games, for example, can experience a first person perspective as the character moves through the (virtual) environment. This enables the creator to provide computer-generated characters and images in the same perspective as the person moving through the virtual environment, such as in a video game or from the perspective of a person in a movie. Again, it is important that the information generated by the motion capture device can be synchronized with the virtual environment created by CGI.

One particular drawback of motion capture devices known in the art, and especially data gloves, is the inability to coordinate among multiple devices capturing data simultaneously. In this respect, if one or more motion capture devices are not identically synchronized, it becomes significantly more difficult to accurately match recorded data during post-production. Obviously, the problem becomes exponentially more complicated the more motion capture devices are introduced. For example, it can be particularly laborious to try and match data for devices that capture sensitive movements that may be expressed through movement of the fingers, wrists and/or forearms. Current post-production firms use computers and other techniques to try and synchronize recorded data. For example, certain movements captured by other cameras may be used to try and synchronize recorded scenes. Retroactively obtaining camera movement data from the captured footage is known as match moving or camera tracking.

Data gloves in particular are input devices that typically fit over the hand of the user, like a glove, or attach to various appendages. Various sensors integrated into the glove allow users to bend or flex various finger joints. The movement is recorded by the sensors and may be reproduced in a virtual world. Some data gloves enable users to interact with objects in that virtual world—and may even provide force feedback in the event a virtual object is struck by the user. Accordingly, such technology is particularly ideal for human interaction with computer generated objects in a virtual reality environment. Motion tracking devices, such as a magnetic tracking device or inertial tracking device, attach to or are otherwise integrated into the data glove to capture various positions, movements and/or rotation of the data glove. These movements are then interpreted by a connected computer software program that accompanies the glove, so the movements can be reproduced on a computer generated screen or environment. For example, certain gestures may be used to convey information or recognize Sign Language or other symbolic functions. These data gloves, however, are not particularly idea for multiple user environments because a lack of data synchronization.

Thus, there exists a significant need for a motion capture data glove that includes a hand wearable flexible glove, one or more sensors coupled to the flexible glove and positioned to measure natural hand movements, a data storage device for at least temporarily storing hand movement information, a communication port configured for bilateral communication with a remote device to coordinate use of a timestamp, and a synchronous time element that imparts the timestamp in real-time to the movement information measured by the one or more sensors and stored by the data storage device to synchronize the movement information with other devices operating simultaneously. The present invention fulfills these needs and provides further related advantages.

### SUMMARY OF THE INVENTION

The motion capture data glove disclosed herein includes a hand wearable flexible glove having one or more sensors coupled thereto. The sensors are positioned to measure natural hand movement when worn by a user. A data storage device at least temporarily stores movement information measured by the one or more sensors. A communication port coupled to the flexible glove is configured to facilitate bilateral communication with a remote device to coordinate use of a timestamp commonly communicated between the motion capture glove and the remote device. Preferably, the communication port includes a wireless communication port and/or a wired communication port. In one embodiment, the communication port simultaneously wirelessly communicates with multiple motion capture data gloves, computer systems, servers, facial cams, body suites or body trackers in real-time. The timestamp is used by a synchronous time element configured to impart the timestamp in real-time to the movement information measured by the one or more sensors and stored by the data storage device. Accordingly, the movement information is synchronized with data generated by at least one other device operating simultaneously, such as another motion capture data glove, a computer system, a server, a facial cam, a body suite or a body tracker.

Additionally, the motion capture data glove may include an identification marker coupled to the flexible glove. The identification marker preferably includes a light, a reflector, a contrasting colored material, or a chroma key contrast material. The identification marker is used to distinguish certain features of the data glove that may not otherwise be readily recognizable. For example, the data glove may include an identification marker that includes an indicator that identifies a feature of a hand, such as the wrist, palm or fingers. More specifically, the identification marker may identify specific fingers or parts of fingers.

Alternatively, the motion capture data glove may further include an armband configured to retain the data storage device, the communication port or the synchronous time element apart from the flexible glove. An attachment mechanism may facilitate selective detachment of the flexible glove from the armband, the data storage device, the communication port, or the synchronous time element. Moreover, an on-board computer processor coupled to the data storage device may selectively process movement information locally or on-board. A power source coupled to the one or more sensors, the data storage device, the communication port or the synchronous time element may include a removable battery, a non-removable rechargeable battery, or a hard wire power source to ensure that the data glove is capable of continually capturing measurement data and processing information.

The related process for capturing and synchronizing movement data with the motion capture data glove may include the step of providing a wearable flexible glove having one or more sensors coupled thereto and configured to measure natural hand movement. The sensors capture natural hand movement for storage in a data storage device, at least temporarily. The motion capture data glove communicates with a remote device through a data communication port coupled to the data storage device to establish a commonly shared timestamp. The timestamp is used to synchronize the captured hand movement with data generated by at least one other device operating simultaneously and independently of the motion capture data glove. This is accomplished by imparting the timestamp to the data stream containing the captured hand movement. The timestamp may be generated by the motion capture data glove or received from the remote device and may be imparted in real-time.

The motion capture data glove communicates through a local communication port. The communication port may exchange information between the motion capture data glove and the remote device through a wireless communication network or a wired communication network. In one embodiment, the motion capture data glove activates a dual channel communication network for communicating information through the wireless communication network and the wired communication network simultaneously. In this respect, high frequency data may be streamed to the data storage device through the wired communication network and low frequency data may be streamed through the wireless communication network. Captured movement data may also be streamed to the remote device.

Furthermore, the motion capture data glove may process captured hand movement on-board; i.e. with a local computer process or other related firmware. As such, energy usage is preferably monitored based on the rate of consumption, depending on the number of devices utilizing the battery or hardwire electrical source. The data glove may automatically power into a sleep mode or an off mode during non-use to conserve energy or save battery life. In this step, the motion capture data glove may make use of a sensor that monitors the voltage usage to determine the rate of energy use or to determine if the device is not being used. Information stored in memory is preferably written to a hard disk or solid state drive before the data glove powers down to a sleep mode or off mode.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an environmental view of a motion capture data glove attached to a portion of a human hand and arm and in wired communication with a computer system;

FIG. 2 is an enlarged view of an armband having a selectively attachable on-board data management system;

FIG. 3 is an environmental view illustrating wireless communication of the motion capture data glove with a central computer system;

FIG. 4 is an environmental view illustration wireless communication among multiple motion capture data gloves;

FIG. 5 is an environmental view illustrating time synchronization among multiple motion capture data gloves;

FIG. 6 is an environmental view illustrating the data glove in a blue/green screen environment and reproduced as a computer animated image;

FIG. 7 is an environmental view illustrating the data glove in a contrasting background environment and including a plurality of blinking lights enhancing visual identification;

FIG. 8 is an environmental view illustrating a plurality of reflectors responding to a light source;

FIG. 9 is an environmental view further illustrating the use of identification markers to specify “right-hand” versus “left-hand” data gloves;

FIG. 10 is a flowchart illustrating multiple means for communicating captured data by the motion capture data glove; and

FIG. 11 is a flowchart illustrating on-board or off-board hardware and software operation of the motion capture data glove.

### DETAILED DESCRIPTION OF THE PREFERRED EMBODIMENTS

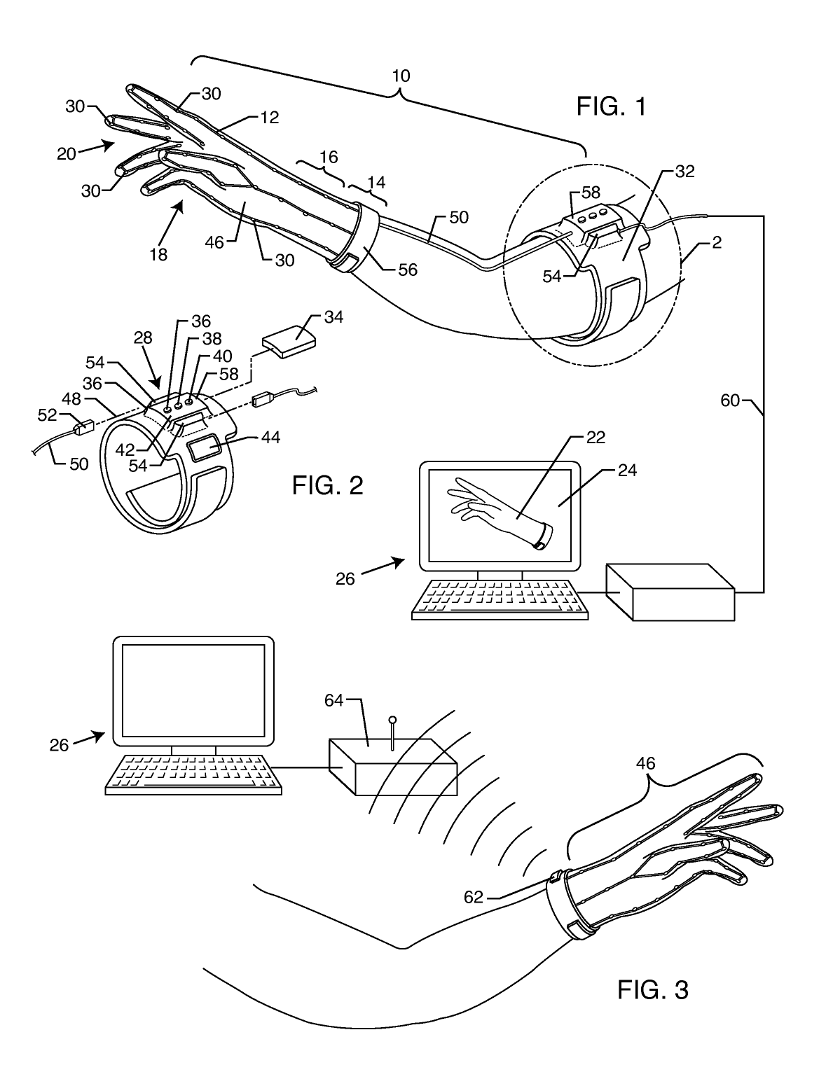

As shown in the exemplary drawings for purposes of illustration, the present disclosure for a motion capture data glove is referred to generally by the reference numeral 10. In general, the motion capture data glove 10, shown in FIG. 1 and described in detail below, is an improved motion capture device designed to enhance and synchronize recorded movement. For example, such a data glove 10 may include one or more sensors 12 that track the movement of a portion of a forearm 14, a wrist 16, a hand 18, one or more fingers 20 (including, e.g., multiple carpus, phalanges, and/or metacarpus), etc. The sensors 12 are designed to track the movement of these body parts 14, 16, 18, 20 at various time intervals in order to create a virtual reproduction 22 of the physical movements of the person wearing the data glove. For example, the virtual reproduction 22 could be displayed in real-time on a computer screen 24, such as the computer screen 24 shown in FIG. 1 with respect to a computer system 26. The sensors 12 may track the relative positioning in the x-axis, y-axis, and z-axis locations and may measure yaw, pitch and roll movements. The sensors 12 relay captured data to the computer system 26 for processing in order to create the virtual reproduction 22, which preferably follows the physical movements of the person wearing the data glove 10. Various prior art data glove designs, however, include limitations and other drawbacks that the data glove 10 disclosed herein improves upon.

More specifically, the motion capture data glove 10 disclosed herein may include (a) an on-board data management system 28 (FIG. 2) that facilitates local data processing, data exchange with multiple devices or computer systems, simultaneous data transmission over multiple communication channels (e.g. both wired and wireless streaming), and/or operation of a power management system; (b) one or more identification markers 30, such as colors (e.g. neon), reflective materials, and/or blinking lights (e.g. LEDs) designed to enhance visual identification of features of the motion capture data glove 10 in motion capture environments; (c) an attachment mechanism 32 that allows for selective detachment and storage of a portion of the data glove 10 during non-use; and (d) various other features such as: (i) a selectively removable power source 34 (FIG. 2) that may include various batteries; (ii) a power LED 36 (monitoring power), wireless/wired communication LED 38 (identifying communication activity), a processor LED 42 (monitoring on-board processing), or a display screen 44 that indicates the status of selectively attachable devices or the operation of already attached and operating devices; (iii) 16-bit as opposed to 8-bit data processing; (iv) power save mode; (v) a battery meter 40 (for monitoring battery life); and (vi) diversified wireless data transmission (e.g. WiFi and/or BlueTooth).

As shown in enlarged view of FIG. 2, the motion capture data glove 10 includes an upper arm attachment mechanism 32 (e.g. a selectively adjustable armband made from neoprene) that provides on-person storage for certain portions of the data glove 10 that may obstruct the user from performing everyday activities during non-use, for example. Preferably, the upper arm attachment mechanism 32 attaches to the upper arm in the position shown in FIG. 1 to provide less obstruction to the movement of the flexible glove 46. This enhances the physical mobility of the flexible glove 46 around the wrist 16, the hand 18 (including the palm) and the fingers 20. By attaching some components of the motion capture data glove 10 to the upper arm, this reduces the weight inertia exerted on the areas near where the sensors 12 collect movement data—i.e. in and around the forearm 14, the wrist 16, the hand 18 and the fingers 20. As a result, reducing the weight inertia in this regard improves recordation of more natural body movements. Alternative embodiments may provide for a means of attaching the upper arm attachment 32 to other appendages, clothing, or other local or remote equipment.

Current data gloves do not provide a means for removing select portions of the data gathering equipment during periods of non-use. Current data gloves also do not provide a means for attaching the removed portion to the body of the user for storage. These features can be particularly cumbersome in the realm of recalibration, repeatability and the overall operability of the data collecting device. For example, the data glove 10 illustrated herein includes portions that cover the forearm 14, the wrist 16, the hand 18, the fingers 20, and event the finger tips. Once put on, the flexible glove 46 must be calibrated to account for the relative positioning (i.e. the “fit”) of the data glove 10 to that particular user. But, prior art devices require complete removal of the entire unit for the user to be able to perform everyday activities (e.g. eat or dial a cell phone) during non-use. These features of the prior art are particularly cumbersome in environments such as motion picture filming because the unit must be recalibrated after being removed. Complete removal increases the likelihood of error. Hence, prior art designs are inefficient and undesirable.

In this regard, the upper arm attachment mechanism 32 is designed to enhance calibration and repeatability of the data glove 10 by ensuring that a portion of the data glove 10 remains attached to the user at all times. For example, the data glove 10 includes the flexible glove 46 made from a thin and lightweight material having one or more sensors 12 stitched, sewn, glued or otherwise mechanically or adhesively integrated therein. The data glove 10 may further include the above-described computer circuitry designed to locally process data measured by the sensors 12 and/or include additional wireless communication equipment, as described in more detail below. In prior art designs, users need to remove both (or all) components of the data glove 10 to free the finger tips, fingers, and the other portions of the hand, palm or thumb to go about doing daily activities, such as using a touch screen cell phone or eating.

The motion capture data glove 10 improves upon these prior art designs by including a feature that allows the user to detach and remove a portion of the data glove 10 that covers the wrist 16, the hand 18, or the fingers 20. For example, FIG. 2 illustrates a detachment mechanism 48 that enables the user to disconnect a wire 50 that provides a line of communication from the sensors 12 coupled to the flexible glove 46 to the on-board data management system 28. In this example, the detachment mechanism includes a USB connector 52 that plugs into a port 54. The USB connector 52 simply unplugs from the port 54 in the manner shown in FIG. 2. The wire 50 otherwise provides a communication channel between the on-board data management system 28 and the sensors 12 coupled to the flexible glove 46. When the USB connector 52 is disconnected from the port 54, the flexible glove 46 may be selectively removed from the forearm 14, the wrist 16, the hand 18 and/or the fingers 20 without removing any portion of the on-board data management system 28, and vice versa. In this respect, the flexible glove 46 may be attached to the wrist 16 by a wristband 56 to make sure the flexible glove 46 does not move other otherwise become dislodged during use. Thus, a portion of the motion capture data glove 10 is removable while the forearm or upper arm portion of the data glove 10 remains securely attached to the user.

During non-use, the user may detach or move removable portions of the motion capture data glove 10, as described above. This allows the user to go about doing everyday activities otherwise not advisable with motion capture equipment attached thereto. Furthermore, detachable portions of the data glove 10 can be attached to one or more different parts of the user or the user's attire. This feature allows the user to carry the detachable portion of the data glove 10, which helps prevent misplacement during times of non-use.

The upper arm attachment mechanism 32 may also include a means for selectively receiving and retaining certain equipment of the motion capture data glove 10. For example, said equipment may mechanically snap, zip, fasten (e.g. via hook and loop fasteners), clip, and the like to the upper arm attachment mechanism 32 during use. FIG. 2 illustrates an embodiment wherein a removable power source 34 (e.g. a removable non-rechargeable battery or a non-removable rechargeable battery) may slide into and be retained by a pocket 58 formed from the upper arm attachment mechanism 32. The pocket 58 may be configured to selectively receive and retain differently sized batteries used to operate the equipment of the motion capture data glove 10. In this respect, the pocket 58 may be made from an elastic material that snugly conforms to the exterior of the power source 34.

Local data storage capabilities allow the motion capture data glove 10 to store recorded and/or processed information locally until it is convenient to transfer the information to the central computer system 26. The local data storage unit may be a hard drive, solid state drive, or other selectively removable storage medium such as an SD card. Preferably, the on-board storage unit is lightweight so that it does not hinder movement of the user. In this regard, SD cards or other light weight solid state storage devices or flash drives are preferred over traditional mechanical hard drives. The data storage device is preferably coupled to the on-board data management system 28, but it may also be coupled to a portion of the flexible glove 46. Eliminating any need to stream data (either wirelessly or wired) at the time of recordation improves data capture consistency because the data glove 10 is no longer reliant on the performance or connectivity of an external device (such as the central computer system 26) or the quality of the network connection. On-board storage also provides faster plug and play transmission and facilitates easier data retrieval.

In one embodiment, the data processing capabilities of the motion capture data glove 10 may be stored remote from the sensors 12. For example, finger, hand and wrist sensors 12 of the data glove 10 may be coupled to wireless circuitry such as WiFi, Bluetooth, RFID, etc. capable of wirelessly transmitting data to a computer processor or on-board storage unit in a location different than where the sensors 12 are located. This is particularly preferred because the flexible glove 46 should be as thin and skin conforming as possible. The data glove 10 may store some of the information in random accessed memory (RAM) before transmitting the information to the on-board storage unit. In this embodiment, the on-board storage unit may be attached to the user's waist to ensure maximum flexibility and operation of the sensors 12 that may be connected to the fingers 20, the hand 18 and/or the wrist 16. A person of ordinary skill in the art will readily recognize that the on-board storage unit could be placed anywhere on the user such as around the ankle, forearm (via the on-board data management system 32) or actually integrated in to the flexible glove 46.

Another feature of the motion capture data glove 10 is that it has multiple communication channels. That is, the data glove 10 can transmit (or stream) information on several different channels simultaneously. For example, as shown in FIG. 1, the data glove may include a wired communication port 60 such as Universal Serial Bus (USB), Firewire, Flash and/or even legacy serial communication cables. Additionally, as shown in FIG. 3, the data glove 10 may further include a wireless communication port 62 that remotely communicates with a receiver 64 coupled to the computer system 26. The wireless communication port 62 may include WiFi and/or Bluetooth communications ports. The data glove 10 may make use of one or more of these communications ports 60, 62 at any given time during the recordation of data or during the transmission of data to the central computer system 26. Accordingly, the data glove 10 can facilitate high frequency streaming to an SD card (or other storage device or card—removable or fixed) via the wired communication port 60 at the same time as low frequency streaming over WiFi to monitor live devices through the wireless communication port 62. Communication with one device over multiple channels, e.g. through WiFi, Bluetooth and/or a hardwire connection such as Ethernet, may increase the amount of information exchanged (i.e. bandwidth) between the communicating devices.

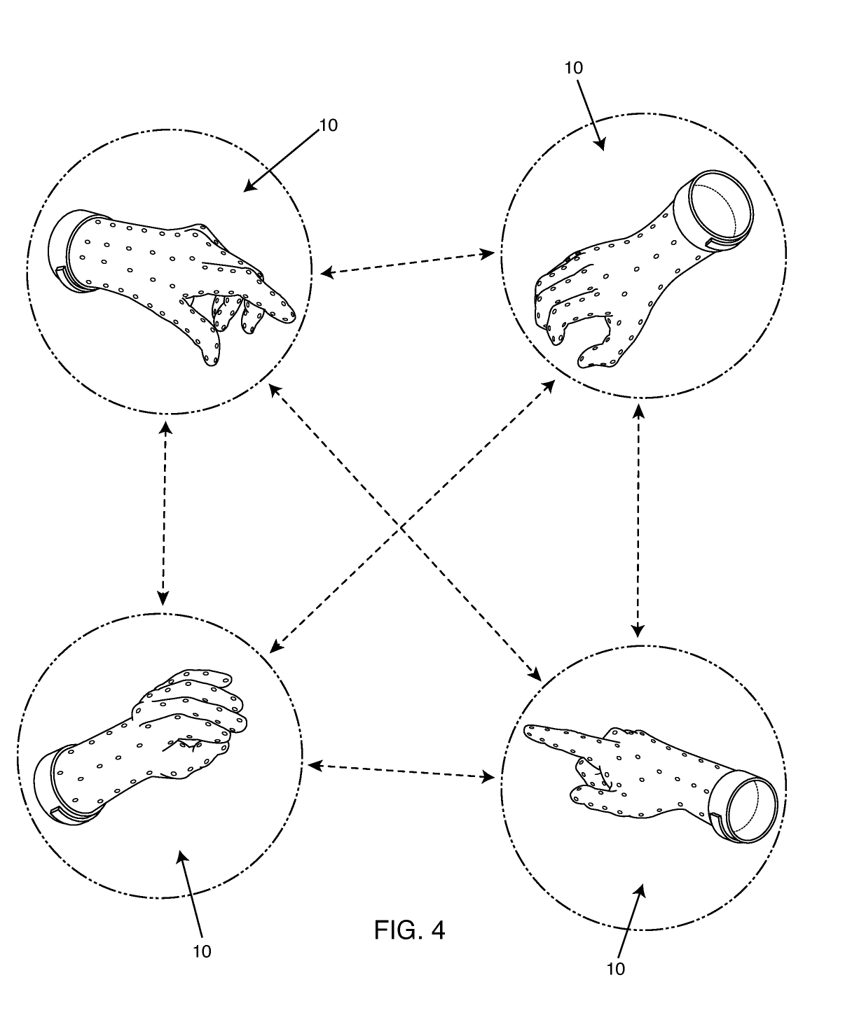

Additionally, as shown in FIG. 4, multiple data gloves 10 may be able to wirelessly communicate with each other. One benefit of this feature, as described in more detail below, is that the multiple data gloves 10 are able to ensure data is recorded in synchronization with one another. In this respect, the data gloves 10 communicate with each other without the assistance of the centralized computer system 26. Alternatively, the data gloves 10 may communicate with a wireless router or other receiver, such as the receiver 64 shown in FIG. 3, as a central communication hub; and in place of the centralized computer system 26. The router/receiver may provide faster routing information among the wireless devices connected within the system—similar to the function of a wireless router with computers connected via WiFi. This enables the data gloves 10 to process and communicate information among one another.

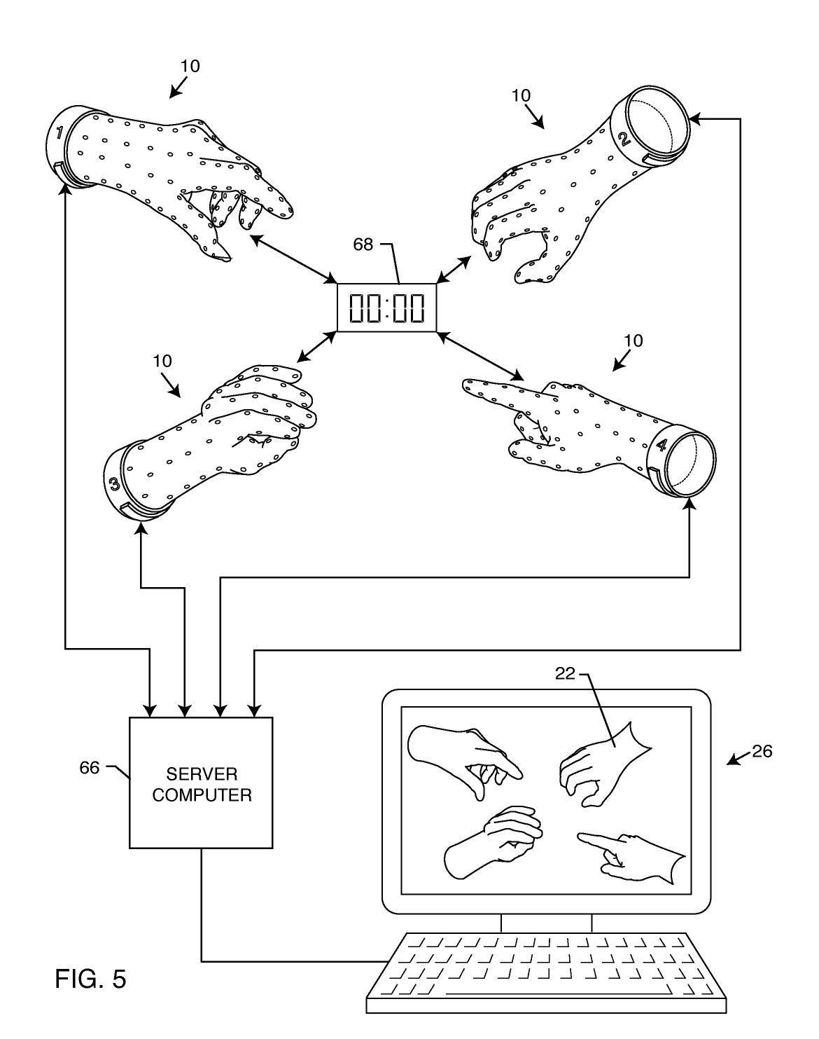

In another embodiment, as shown in FIG. 5, the data gloves 10 may communicate with a remote server 66 that is capable of processing data and relaying information back to the data gloves through bi-lateral communication. Simultaneous data handling in this regard allows the data gloves 10 to communicate with multiple devices at once. In this embodiment, the data gloves 10 are each illustrated communicating with the remote server 66, which is connected to the computer system 26 depicting the virtual reproduction 22 of each data glove 10. The data gloves 10, as described above, may, alternatively, communicate directly with the computer system 26 or with each other (as shown in FIG. 4). These features may enhance synchronization with other audio or visual recordings in, e.g., a motion picture or video game production environment.

Moreover, the data glove 10 may include a synchronous time element that communicates with another device to obtain a timestamp used to synchronize all devices recording data within a single environment. FIG. 5 further illustrates a central time-keeping device 68 in bilateral communication with each of the data gloves 10. The central time-keeping device 68 is preferably a computer or other communication device (e.g. a data glove 10) that can relay timestamp information to each of the data gloves 10 through the aforementioned wired communication port 60 or the wireless communication port 62. For example, each data glove 10 may need to plug into the central time-keeping device 68 to obtain timestamp information to be applied to recorded data (so-called in the industry as “jam Sync”). Alternatively, the data glove 10 could simply communicate with the central time-keeping device 68 through a wireless transmission protocol that contains timestamp information. In this respect, it is preferable that the data glove 10 be compatible with known jam Sync systems to seamlessly synchronize with other motion capture devices in the industry. The central time-keeping device 68 may be portable (i.e. it can be transported to the location of the data glove 10) or stationary (i.e. the data glove 10 is taken to a time-keeping device 68 in a fixed location). The important aspect is that the data glove 10 is able to communicate with the central time-keeping device 68 such that it receives a timestamp that commonly synchronizes with all other devices (e.g. other data gloves or motion capture devices) recording data as part of a common project (e.g. film production). All devices that plug into or otherwise communicate with the central time-keeping device 68 synchronize with one another so data recordation, e.g. audio/visual data collected by multiple devices such as data gloves, trackers, facial cams, etc., stay synchronized.

Alternatively the central time-keeping device 68 may be in the form of a computer chip integrated into one of the data gloves 10. In this respect, one data glove 10 may generate the timestamp, which is to be used for synchronizing with all other devices (including other data gloves 10) connected to the system.

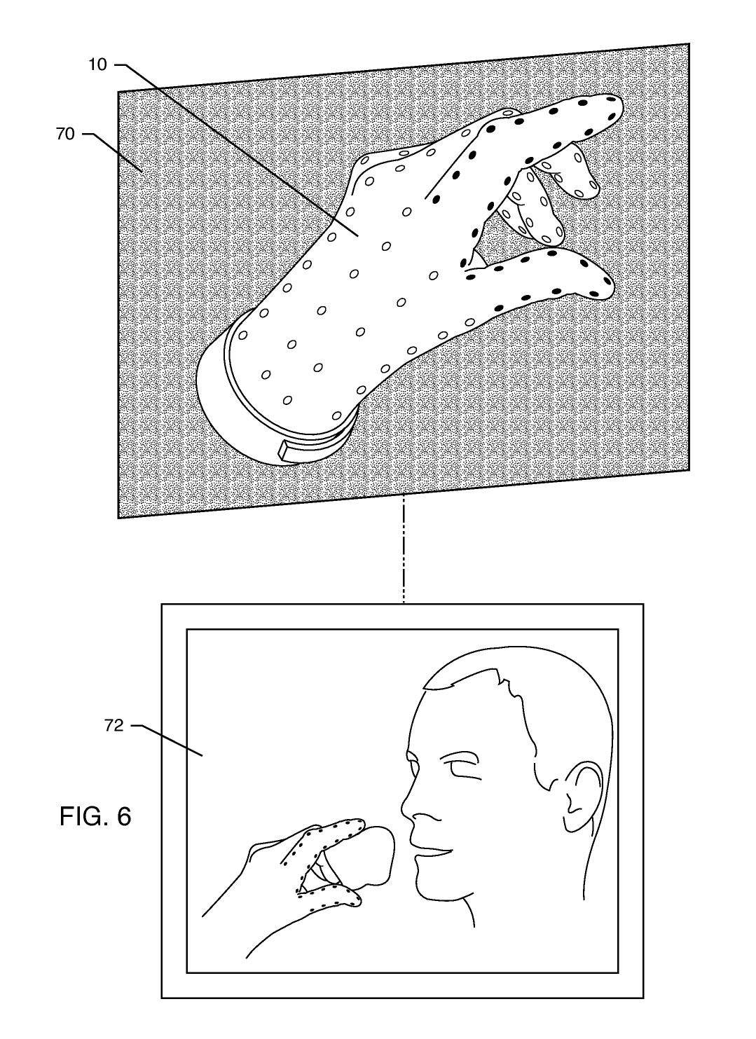

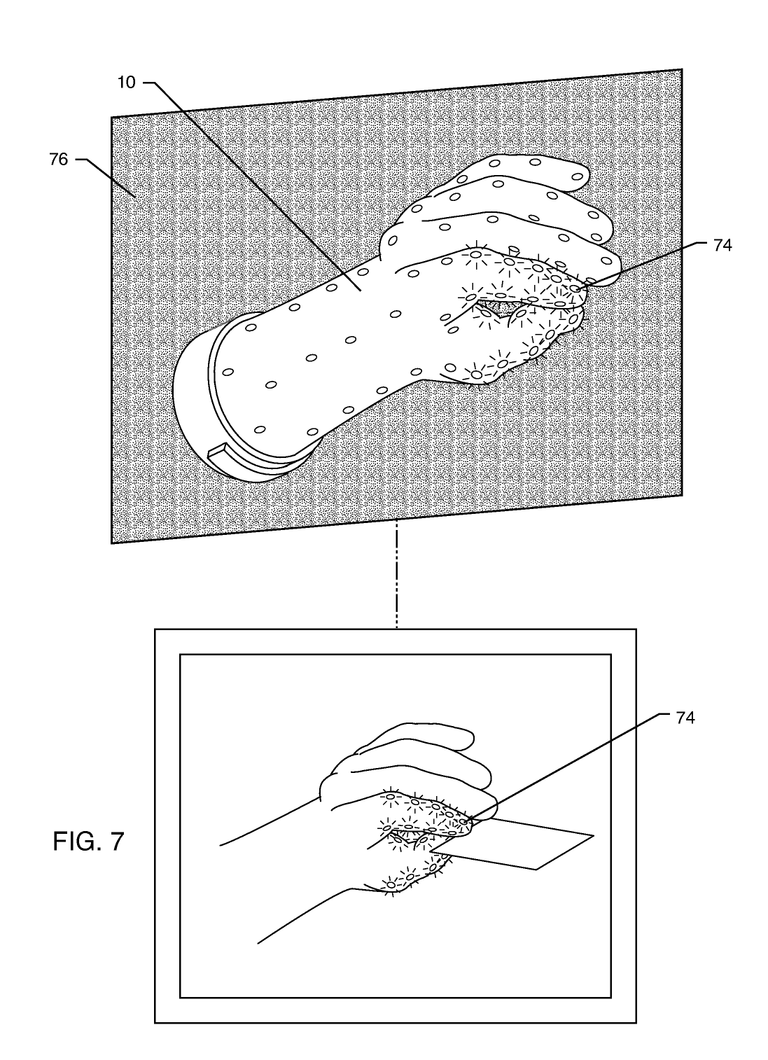

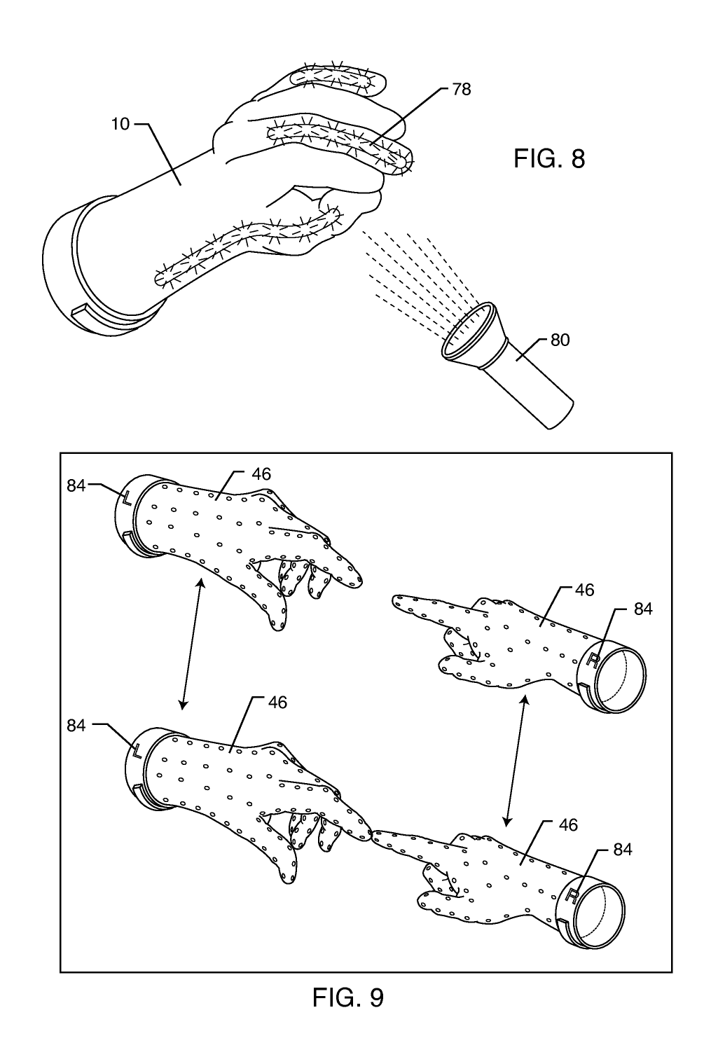

The motion capture data glove 10 may also include a variety of identification markers 30 such as colors (e.g. neon), reflective materials, and/or blinking lights (e.g. LEDs). The identification markers 30 provide image enhanced recognition of the data glove 10 during recordation. For example, as shown in FIG. 6, the data glove 10 may be used in association with a green and/or blue screen 70 to enhance computer generated imagery (CGI). As such, during production of a film or video game, the director may be able to watch movement of the data glove 10 through a computer animated environment 72 through use of chroma key compositing. The identification markers 30 may change in color or light intensity depending on the application. For example, it may be difficult to discern specific parts of the data glove 10 when viewing the data glove 10 through a camera that displays the scene in black and white. Using a contrasting color scheme or using a set of blinking lights 74 (FIG. 7) will enhance image recognition in a black and white environment. Moreover, FIG. 7 illustrates a black backdrop 76 that contrasts the white data glove 10 to enhance glove recognition. Using neon colors may further enhance recognition in color environments. Alternatively, FIG. 8 illustrates the use of a plurality of reflective materials 78 responsive to a light source 80 (e.g. a flashlight, or a black light) in the recording or production environment. In general, the above-mentioned identification markers 30 are designed to provide better visibility to the person operating the camera. This is especially important because movies and television shows are increasingly reliant on technology that uses green and/or blue screen environments to record scenes.

The identification markers 30 may also identify the type of hand (e.g. “right hand” versus “left hand”), features of the data glove (e.g. hands, fingers, wrists, thumbs, etc.), unique and/or distinct data gloves (e.g. the data glove of one person as opposed to another), etc. For example, FIG. 9 illustrates a data glove 10 having a “right hand” flexible glove 46 designated by a letter “R” 82 and a “left hand” flexible glove 46 designated by a letter “L” 84. The flexible glove 46 preferably includes some unique marking that identifies each glove 46 as right-handed or left-handed handed. This may enable the camera operator to specifically shoot a particular hand, depending on the scene. Likewise, the data glove 10 may include similar markings that identify more specific features of each data glove 10 (e.g. hands, fingers, wrists, thumbs, etc.), unique and/or distinct data gloves (e.g. the data glove of one person as opposed to another), etc. The important aspect is that the markers provide unique identification of the particular aspect of the glove 10 designed to be identified. The markings may be numbers, characters, alphanumeric characters, symbols, shapes, or any combination thereof. These features are deployable for use in motion capture environments and audio/video recording environments in general. While the prior art may be able to identify between right-hand and left-hand gloves, such prior art does not provide any means for providing the above-described features that contrast the visual presentation of certain features of the data gloves (or the data gloves themselves) relative to various background environments in order to enhance visualization of the glove through the camera lens.

Other features of the motion capture data glove 10 include, e.g., variable power source capabilities. This particular feature allows the data glove 10 to receive and operate with different battery sizes. For example, the data glove 10 may be compatible with larger batteries for extended operating periods and may be compatible with smaller batteries designed for shorter operating periods. Shorter and smaller batteries are particularly useful in situations where high mobility is particularly desirable. The data glove 10 also includes a set of LEDs, as briefly described above, that provide visual notification of the status of various glove features such as battery life, wireless communication transmission, errors, etc. The LEDs may be simple single color LEDs or multi-color LEDs (e.g. tri-color). The motion capture glove 10 also includes 16-bit A-D conversion and 16-bit internal sensor data management—as opposed to 8-bit data processing. This feature provides compatibility with higher resolution sensors with no loss in precision in the firmware. When not in use, the data glove 10 includes a power save mode designed to enhance battery life. The data glove 10 may also include a single button or wake-on-device to provide seamless integration without hard firmware or software restarts. Battery monitoring also provides awareness (through an external display or otherwise) of the amount of charge remaining in the batteries to enable better battery management during motion capture shoots. Further features of the motion capture data glove 10 include wireless connectivity, e.g. WiFi and/or BlueTooth. In a particularly preferred embodiment, the data glove uses WiFi wireless technology to transmit higher resolution data, facilitate more simultaneous connections, increase operating range (e.g. over 150 ft.), consistency, etc. WiFi also enables the data glove to receive and even assign a static IP address, which improves unique recognition during motion capture and post-processing. The data glove 10 may also include a mount for receiving a camera that captures visual data.

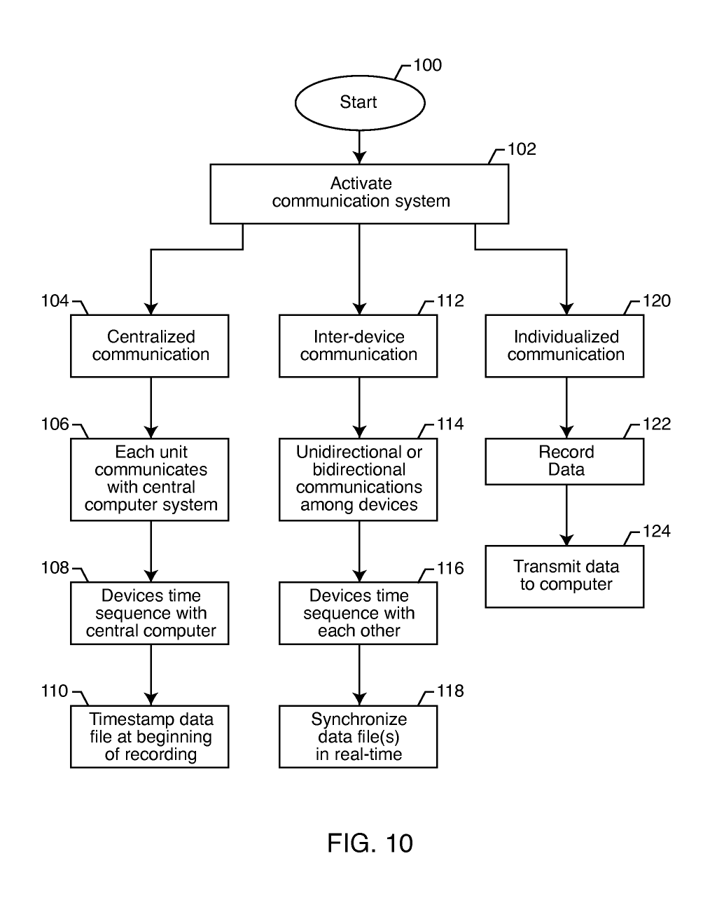

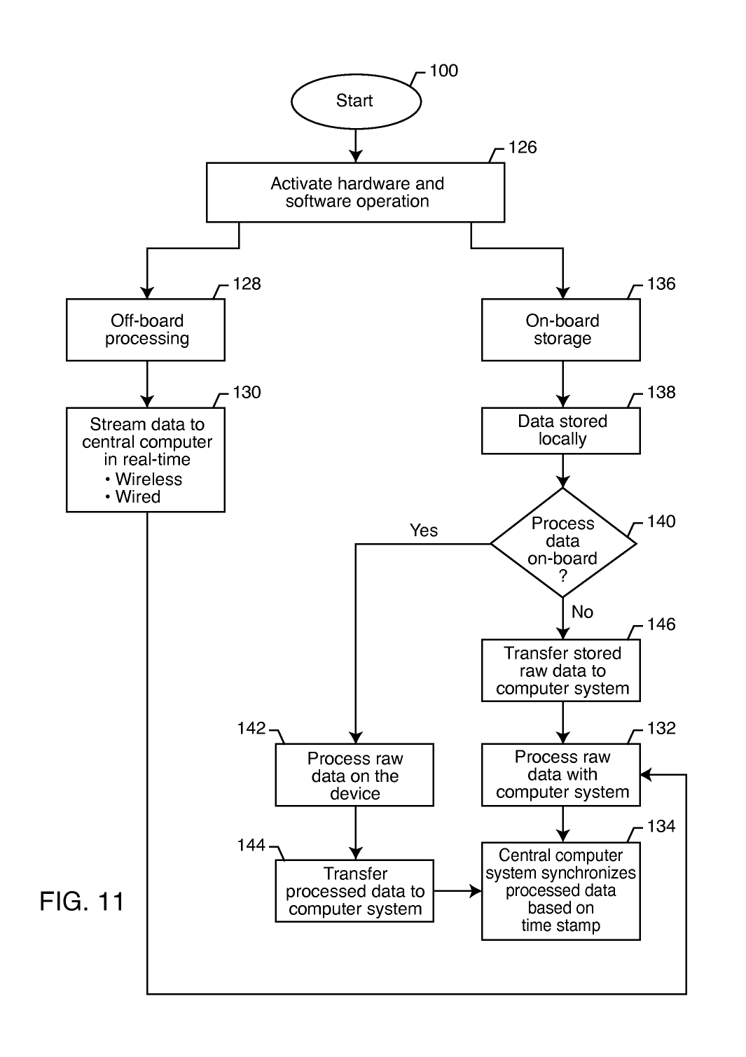

FIGS. 10 and 11 further illustrate sample operation of the motion capture data glove 10, as described above. For example, FIG. 10 is a flowchart illustrating the various ways of capturing and synchronizing data in association with the embodiments described herein. Here, the system starts (100) by turning the data glove 10 to the “on” position from an “off” or “sleep” mode. Once, on, the software or firmware running the data glove 10 activates the communication system (102). This may include activating any of the above described wireless or wired communication systems. One important aspect of the data glove 10 is the ability to synchronize recorded data with other data recordation (e.g. other data gloves, facial cams, body suits, etc.). In one embodiment, this is accomplished by communicating with a centralized communication system (104). Here, the motion capture data glove 10 communicates information with a central computer, server or other network hub or router (106). The central computer system is the central point of contact for information exchange among multiple data gloves 10 operating in the same motion capture environment. As such, the timestamp may be generated by the central computer system and communicated to any data gloves 10 in communication therewith. In an alterative embodiment, the timestamp may be generated by another remote device or one of the data gloves 10. At this point, all connected devices receive the timestamp information from the central computer system (108). In terms of the data glove 10, the timestamp is at least imparted to the beginning of the recording (110) so that recorded data can later be synchronized with other recordings occurring simultaneously. Alternatively, the data glove 10 may continuously stream information to and/or from the central computer system, thereby constantly receiving updated timestamp information. In turn, timestamp information may be constantly (i.e. at some predetermined interval) written to the recorded data in real-time. This ensures that data recorded from all the data gloves 10 remain synchronized.

Alternatively, multiple data gloves 10 may intercommunicate among one another in step (112). Here, the timestamp information is not necessarily coordinated through use of a central server. Instead, the communication ports of each data glove 10 are designed to communicate with one another. This is more akin to peer-to-peer (P2P) file sharing over a network. One advantage of this embodiment is an overall reduction of processing requirements on any one computer system or device. Accordingly, bandwidth can be spread out among the multiple data gloves 10 capturing data simultaneously. Each of the data gloves 10 preferably engaged in bidirectional communication (114) among each other. This enables the timestamp to be adequately shared, or continuously shared, in accordance with the embodiments described above. In this embodiment, the timestamp may be generated by a central timestamp device, or the timestamp may be generated by one of the data gloves 10. In the embodiment of a central timestamp device, the timestamp information is first communicated by the central time-keeping device 68 and propagated throughout the system by each of the intercommunicating data gloves 10. The central time-keeping device may issue periodic timestamp information to make sure each of the data gloves 10 remain synchronized. In a similar sense, one of the data gloves 10 (e.g. one designated as the “alpha” or first priority data glove 10) may generate the timestamp information such that each of the other data gloves (e.g. “beta” gloves or lower priority data gloves 10) utilize that timestamp to synchronize data recordation. In this embodiment, the data gloves 10 sequence with each other (116). The use of a common timestamp used among all the data gloves 10 ensures that the data files on each device, whether stored locally (e.g. on-board) or streamed to a local computer system, remain synchronized (118).

In another embodiment, each data glove 10 may be responsible for individual communication (120) with the central time-keeping device 68 to record data that can be later synchronized. This embodiment may be used in the event there are other data recordation devices (not necessarily data gloves 10) being used in a motion capture environment. Here, the data glove 10 will record data (122) and at least temporarily store the captured data on-board. The timestamp data is preferably received from the aforementioned central time-keeping device 68 (which may be used to communicate said timestamp information among multiple other devices in the motion capture environment); although the timestamp may be self-generated by the data glove 10 or self-generated by the data glove 10 and communicated to the central time-keeping device 68 or to other connected devices. To complete the synchronization of captured data, the data glove 10 then transmits the data to a computer system (124) for eventual processing with other captured data.

With respect to the on-board data management and processing system 28, the motion capture data glove 10 may include a computer processor, memory and various other computer circuitry embedded into the flexible glove 46 (FIG. 3) or an accessory coupled thereto (e.g. the upper arm attachment mechanism 32 shown in FIG. 1), to facilitate data management before recorded data is relayed to the central computer system 26. Importantly, this feature reduces the load on the central computer system 26 responsible for post-processing data. Motion capture devices known in the art are designed to capture data as it is recorded by the sensors 12. But, these devices are not equipped to process data locally. As such, prior art devices send the information directly to the central computer system as it is recorded by the sensors. This creates two problems: (a) overloading the processing capability of the central computer system; and (b) potential communication loss, especially when steaming data over a lower bandwitdth wireless network. In this respect, prior art motion capture devices are especially inefficient as the central computer system bears the responsibility for processing all the data and, at times, receiving that data at the same time. The central computer system 26 may easily capture and process data for one or only a few devices (e.g. less than ten). But, as the data load increases, the central computer system 26 may become overloaded and fail to efficiently process data. With increased use of multiple data capturing devices such as multiple data gloves, body trackers, facial cams, etc., this process will prove to be unfeasible in the long-term.

The motion capture data glove 10 improves upon the above-mentioned inefficiencies by facilitating processing for each device locally through on-board data processing. The data glove 10 includes computer code designed to encode information recorded by the sensors 12. The data glove 10 may include one or more processors for processing and encoding data. For example, the data glove 10 may include one processing unit (processor, memory, and other requisite circuitry) that processes data measured by the sensors 12 designed to measure movements of the wrist. Another data processing unit may function similarly, but with respect to the hand or the fingers. The computer code can run as software or firmware that may be modified or upgraded as needed through wireless or wired communication with a remote computer system. The central processing unit uses the computer code to process the data locally as it is recorded by the sensors 12. This feature may be deployed in an environment that uses multiple data gloves 10 or an environment that uses multiple data gathering devices, such as body trackers, facial cams, etc. Data processed locally is later transmitted to the central computer system 26 for synchronization with information collected and processed by other data gloves. This provides faster, more reliable synchronization with other data input devices in the motion capture environment (e.g. other data gloves, full-body suits, facial cams, etc.) as it decentralizes the processing load.

The flowchart shown with respect to FIG. 11 illustrates operation of the aforementioned data management system as integrated into the motion capture data glove 10 described herein. A user starts the system (100) in accordance with the embodiments described above. The next step is then to activate the hardware and software operation (126) of the data glove 10. Here, the data glove 10 may be programmed for on-board processing and/or off-board processing. Of course, whether the data glove 10 is capable of performing on-board and/or off-board processing depends on the connected components. As described above, components such as the data storage device or the processor may be selectively disconnected from the data glove 10. When the processing components are disconnected, the data glove 10 operates through off-board processing (128). In this regard, the data glove 10 may stream or otherwise send captured measurement data to the centralized computer system 26, preferably in real-time (130). This may occur over the aforementioned wireless or wired communication network. A remote computer or server may then process the raw data (132). A centralized computer system then synchronizes the processed data based on the timestamp applied to the data stream (134), as described above. This ensures that multiple data gloves 10 can record and deliver multiple streams of data simultaneously, and that such data will be easily synchronized by the central computer system 26.

Alternatively, in the event processing capabilities are present and connected (and assuming the user selects this option) to the data glove 10, the system can perform on-board processing (136). Here, the data is stored locally (138) on the data storage device, as described above. From here, the user may have the option, again if the processing components are present, to determine whether to process that information on-board or off-board (140). The benefit of on-board processing is that each data glove 10 will interpret and process raw data on the device itself (142). This reduces the load on the central computer system 26. In essence, the data processing capabilities are spread out among multiple processors, which can increase the real-time processing and synchronization capabilities of the motion capture data glove 10. This processed data is then transferred to the central computer system (144) where the different data streams are simply synchronized based on the timestamp information applied to the data stream at the time or recordation or the time of data processing (142). One drawback of this feature is that on-board processing (142) may drain the battery source of the data glove 10. Although, this is less of a concern in the event the data glove 10 is hardwired to a power source, such as through a USB connection or through a separate power cable. Alternatively, the user may choose to processing the data feed stored by the data storage device off-board during step (140). In this case, the raw data is simply transferred to the central computer system (146) for processing. Once transferred, the central computer system processes the raw data in accordance with the embodiments described above with respect to steps (132) and (134).

Alternatively, the flexible glove 46 may communicate with the on-board data management system 28 via the wireless communication port 62. In this embodiment, information may be exchanged between the information collected by the sensors 12 and the on-board data management system 28 without any structural or mechanical linkage.

Although several embodiments have been described in detail for purposes of illustration, various modifications may be made to each without departing from the scope and spirit of the invention. Accordingly, the invention is not to be limited, except as by the appended claims.

What is claimed is:

1. A motion capture data glove, comprising:
a hand wearable flexible glove having one or more sensors coupled thereto and positioned to measure natural hand movement;
a data storage device that at least temporarily stores movement information measured by the one or more sensors;
a communication port configured for bilateral communication with a remote device to coordinate use of a timestamp commonly communicated between the motion capture data glove and the remote device; and
a synchronous time element configured to impart the timestamp in real-time to the movement information measured by the one or more sensors and stored by the data storage device to synchronize the movement information with data generated by at least one other device operating simultaneously.

2. The data glove of claim 1, including a power source coupled to the one or more sensors, the data storage device, the communication port or the synchronous time element.

3. The data glove of claim 2, wherein the power source comprises a removable battery, a non-removable rechargeable battery, or a hard wire power source.

4. The data glove of claim 1, wherein the communication port comprises a wireless communication port or a wired communication port.

5. The data glove of claim 4, wherein the communication port simultaneously wirelessly communicates with multiple motion capture data gloves, computer systems, servers, facial cams, body suites or body trackers in real-time.

6. The data glove of claim 1, wherein the remote device comprises at least one of another motion capture data glove, a computer system, a server, a facial cam, a body suite or a body tracker.

7. The data glove of claim 1, including an on-board computer processor coupled to the data storage device for processing movement information locally.

8. The data glove of claim 1, including an identification marker coupled to the flexible glove.

9. The data glove of claim 8, wherein the identification marker comprises a light, a reflector, a contrasting colored material, or a chroma key contrast material, or an indicator that identifies a feature of a hand.

10. The data glove of claim 1, including an armband configured to retain the data storage device, the communication port or the synchronous time element apart from the flexible glove.

11. The data glove of claim 10, including an attachment mechanism that facilitates selective detachment of the flexible glove from the armband, the data storage device, the communication port, or the synchronous time element.

12. A process for capturing and synchronizing movement data with a motion capture data glove, comprising the steps of:
providing a wearable flexible glove having one or more sensors coupled thereto and configured to measure natural hand movement;
capturing natural hand movement with the one or more sensors;
storing the captured hand movement at least temporarily in a data storage device;
communicating with a remote device through a data communication port coupled to the data storage device to establish a commonly shared timestamp; and
synchronizing the captured hand movement with data generated by at least one other device operating simultaneously and independently of the motion capture data glove by imparting the timestamp to a data stream containing the captured hand movement.

13. The data glove of claim 12, wherein the communicating step includes the step of exchanging information between the motion capture data glove and the remote device through a wireless communication network or a wired communication network.

14. The data glove of claim 13, including the step of activating a dual channel communication network for communicating information through the wireless communication network and the wired communication network simultaneously.

15. The data glove of claim 14, including the steps of streaming high frequency data to the data storage device through the wired communication network and streaming low frequency data through the wireless communication network.

16. The data glove of claim 12, including the step of generating the timestamp with the motion capture data glove or receiving the timestamp from the remote device.

17. The data glove of claim 12, including the step of processing the captured hand movement on-board the motion capture data glove.

18. The data glove of claim 12, including the step of imparting the timestamp to the data stream in real-time.

19. The data glove of claim 12, including the step of streaming the captured hand movements to the remote device.

20. The data glove of claim 12, including the step of automatically powering the motion capture data glove into a sleep mode or an off mode during non-use.

21. The data glove of claim 20, wherein the powering step includes the step of sensing a usage voltage to determine non-use.
